(19) United States
(12) Patent Application Publication
(10) Pub. No.: US 2007/0149071 A1
(43) Pub. Date: Jun. 28, 2007

(54) Needled belt with high thickness and elasticity

(76) Inventor: Giancarlo Cassarino, Venezia (IT)

Correspondence Address: FROMMER LAWRENCE & HAUG, 745 FIFTH AVENUE- 10TH FL., NEW YORK, NY, 10151, US

(21) Appl. No.: 11/515,155

(22) Filed: Sep. 1, 2006

Related U.S. Application Data
(60) Provisional application No. 60/714,165, filed on Sep. 2, 2005.

(51) Int. Cl. B32B 5/02; B32B 9/00

(52) U.S. Cl. 442/59

(57) ABSTRACT

A multi-base needled belt having an elastic surface comprising a conventional base layer, an elastic base layer and at least two batt layers needled into both base layers in order to join the base layers to each other, wherein the belt's elasticity derives from elastic fibers that are used to construct the elastic layer.

### CROSS-REFERENCE TO RELATED APPLICATIONS

This application claims priority benefits of U.S. Provisional Patent Application Ser. No. 60/714,165 filed Sep. 2, 2005 entitled “Needled Belt with High Thickness and Elasticity”, the disclosure of which is incorporated herein by reference.

### BACKGROUND OF THE INVENTION

1. Field of the Invention

The instant invention relates generally to the production of textiles. More specifically, the instant invention relates to a textile machine belt that is used to finish or compact knitted fabrics.

2. Background of the Invention

Generally, machine fabrics or belts of this type are used in the manufacturing of textiles. More specifically, textile machine belts of a type similar to that of the instant invention, are used as so-called compacting belts. Compacting belts are used on special machines (compacting machines) to render materials, such as knitted fabrics, shrinkproof. Materials that have been processed by a compacting machine remain de facto shrinkproof during the first wash. This process is commonly used in the production of clothing.

A standard belt used on a textile compacting machine is usually relatively thick, ranging from between 16 mm and 22 mm in thickness. Compacting machine belts are typically manufactured using polyamide, polyester and aramid fibers. When used on such machines, the belt must undergo several looping processes, wrapping around several rolls or cylinders often having different diameters. As the belt travels through the machine, its internal and external surfaces reverse from roll to roll.

Depicted in FIG. 1 is a typical textile compacting machine. A compacting belt 2, having an internal machine surface 4 and an external product surface 6 and traveling in the direction of the arrows in the figure, first wraps around a driving roll 8. At the point of the driving roll 8, the textile or cloth 10 to be compacted is introduced into the compacting machine and placed in contact with the external surface 6 of the compacting belt 2. The cloth 10 now carried by the compacting belt 2, becomes sandwiched 11 between the compacting belt 2 and a steam heated cylinder 12. The combined effect of compressing the cloth 10 between the compacting belt 2 and the steam heated cylinder 12 and heating the cloth with steam, results in for example a knitted fabric material cloth that is dimensionally stabilized and resistant to shrinkage.

The compacting belt's thickness, however, is problematic. When the belt 2 wraps around the driving roll 8, its internal machine side 4 becomes compressed and shortens while its external product side 8 becomes stretched and elongated. When the curvature of the belt 2 is reversed at the steam heated cylinder 12, the external product side 6 now becomes compressed and shortens while the internal machine side 4 becomes stretched and elongated. This alternating compressing and stretching of the belt's opposing surfaces is depicted by the boxes 13 and the trapezoidal shapes 15 in FIG. 1.

Due to the stretching and compressing of the belt 2, the external product side surface 6 can lose its consistency or smoothness. As a result, the external product side surface 6 becomes irregular, leading to marking problems on the processed cloth's surface. In addition, cracks can occur in the belt, limiting the serviceable life of the belt. It has also been demonstrated that the serviceable life is not only reduced by the movements of the compacting belt around the cylinders or rolls, but also by other influences on the belt, such as residue from acid dyes or bleaching agents that are introduced into the belt from the materials being processed.

Attempts have been made to solve the above-described problems associated with prior belts. For example, U.S. Pat. No. 6,479,414 (“the '414 patent”) discloses a textile machine belt consisting of a ground textile, a belt layer, an elastic knit fabric and an uppermost layer. As disclosed, the elastic knit fabric is a warp or circular knitted article in the form of a knitted sleeve. Elasticity of the machine belt comes from the physical structure of the elastic fabric being a knit because an inherent characteristic of certain knitted articles is their elasticity. That is, a knitted article's structure allows it to expand and contract (stretch and compress) without affecting the article's integrity.

The instant belt differs from that of the '414 patent in that the elastic base layer of the instant belt is flat woven with elastic fibers and not knitted with in-elastic fibers. Therefore, the elasticity of the instant belt derives from the use of elastic fibers in the flat woven elastic base layer. Hence, the instant belt can be produced using a variety of textile methods and is not, as is the case with the '414 patent, limited to only warp knitting or circular knitting techniques. Furthermore, the structure of the instant belt differs over that of the '414 belt in that the external product side and the internal machine side of the instant belt consist of batt fibers that have been needled into the base layers. The belt of the '414 patent speaks of a “stitched” felt layer 2 and fibrous layer 4 between which a knitted layer 3 is disposed. But again, the elasticity is due to the structure, i.e., the knit rather than due to the elastic material itself.

Accordingly, a need exists for a belt that is capable of being subjected to alternating and repetitive stretching and compressing of its surfaces so that its external machine side surface does not become irregular, resulting in marking of a textile cloth processed thereon. Furthermore, a need exists for a belt that is capable of being manufactured using a variety of textile methods. The instant invention is directed to overcoming shortcomings associated with prior art belts.

### SUMMARY OF THE INVENTION

It is therefore a principal object of the invention to provide a belt that is capable of repetitive and alternating stretching and compressing without adversely affecting the belt's desired properties.

It is a further object of the invention to provide a belt where the belt's elasticity allows both surfaces of the belt to stretch and elongate as well as to compress and shorten based on the belt's orientation when wrapped around various rolls or cylinders.

Yet another object of the invention is to provide a multi-base belt wherein at least one of the base layers is elastic.

It is a further object of the invention to provide an elastic belt having an elastic base layer, wherein the belt's elasticity is derived from elastic fibers used to construct the elastic base layer.

A still further object of the invention is to provide an elastic belt that has needled batt layers for both its internal machine side and external product side surfaces.

Yet another objective of the invention is to provide an elastic belt that is capable of being produced using a variety of textile methods.

A still further objective of the instant invention is to provide a belt that is more durable, resulting in an increased service life.

These and other objects and advantages are provided by the instant invention. In this regard, the instant invention is directed to a machine belt that is used in the manufacturing of textiles. The instant belt comprises a conventional base layer, an elastic base layer and batt fibers that are needled from an exterior surface of each base layer, into both base layers. The elastic base layer is flat woven and is constructed using elastic fibers made from natural, nitrile or silicone rubber. In addition, synthetic materials, such as but not limited to, LYCRA® and ELASTAN® (may be used to construct the elastic base layer. In order to protect the elastic fibers from significant damage during the batt needling process, the elastic fibers are coated with a polymeric resin such as polyurethane or silicone. Alternatively, the elastic fibers can be processed into a composite yarn such that the elastic fibers are primarily in the core or central portion of the yarn and are wrapped with an outer layer of fiber such as polyester. This outer layer can be a multifilament yarn which is twisted or spiraled around the elastic core, or may be of all multifilament construction. In order to further protect the composite elastic yarns from significant needling damage, the composite yarns may also be coated with a polymeric resin such as polyurethane or silicone.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a cross-sectional view of a textile compacting machine;

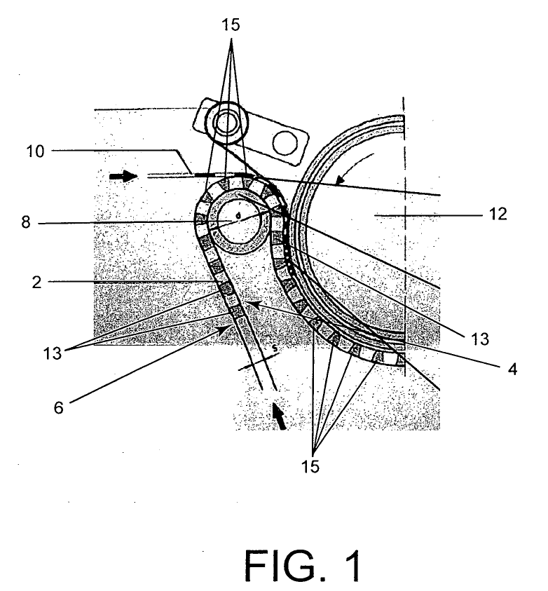

FIG. 2 is a cross-sectional view of a multi-base needled belt, according to one embodiment of the instant invention;

FIG. 3 is a cross-sectional view of a multi-base needled belt, according to one embodiment of the instant invention;

FIG. 4 is a cross-sectional view of the multi-base needled belt that was manufactured according to the embodiment of FIG. 3; and

FIG. 5 is a side view of a composite yarn in the expanded state showing the double fiber layer of the outer protective layer, according to one embodiment of the instant invention.

### DETAILED DESCRIPTION OF THE PREFERRED EMBODIMENTS

The instant invention relates to a multi-base needled belt for use in textile manufacturing. As previously discussed, prior art belts are problematic because their inelasticity causes the surface of the belts to become cracked and irregular, resulting in marking on a textile cloth being processed. In addition, the problems associated with the prior art belts result in less durable belts that have shorter service lives.

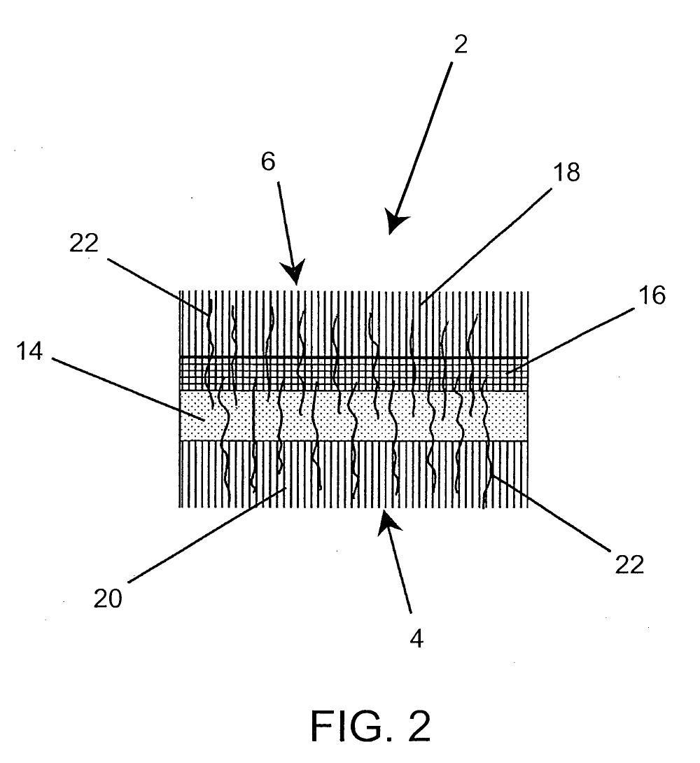

The instant invention provides a belt that is more elastic and more durable than prior belts. FIG. 2 depicts the configuration of a multi-base needled belt constructed according to one embodiment of the instant invention. As depicted, a conventional base layer 14 is located adjacent to the internal machine side 4 of the belt 2 and an elastic base layer 16 is located adjacent to the external product side 6 of the belt 2. In order to attach the conventional base layer 14 and the elastic base layer 16 to one another, a top or external batt layer 18 and a bottom or internal batt layer 20 are needled from an exterior surface of each base layer into both base layers, 14 and 16. Therefore, the needled batt fibers 22 physically join the two layers to each other. The batt layers, 18 and 20, also provide a product side and a machine side contact surface.

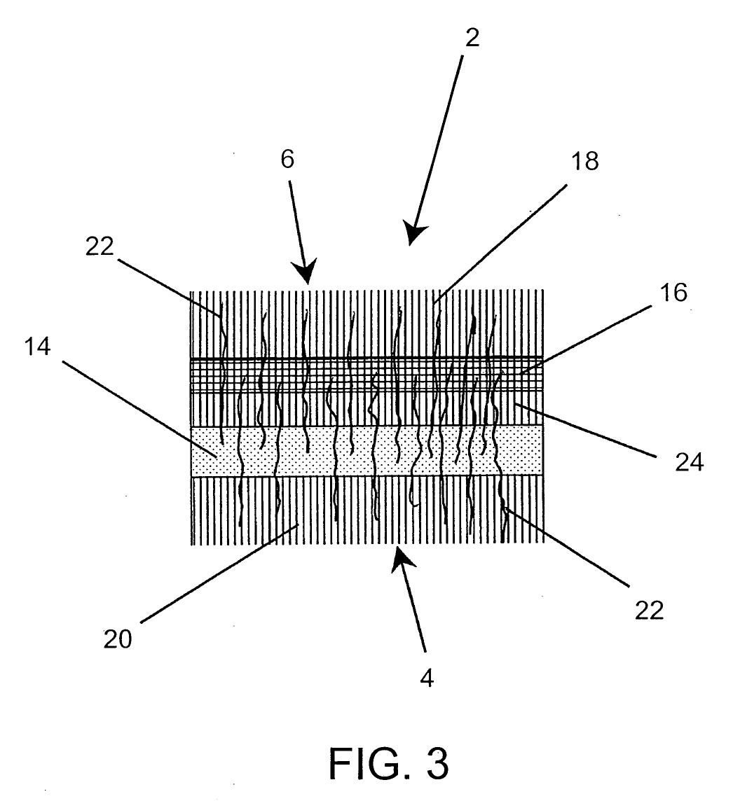

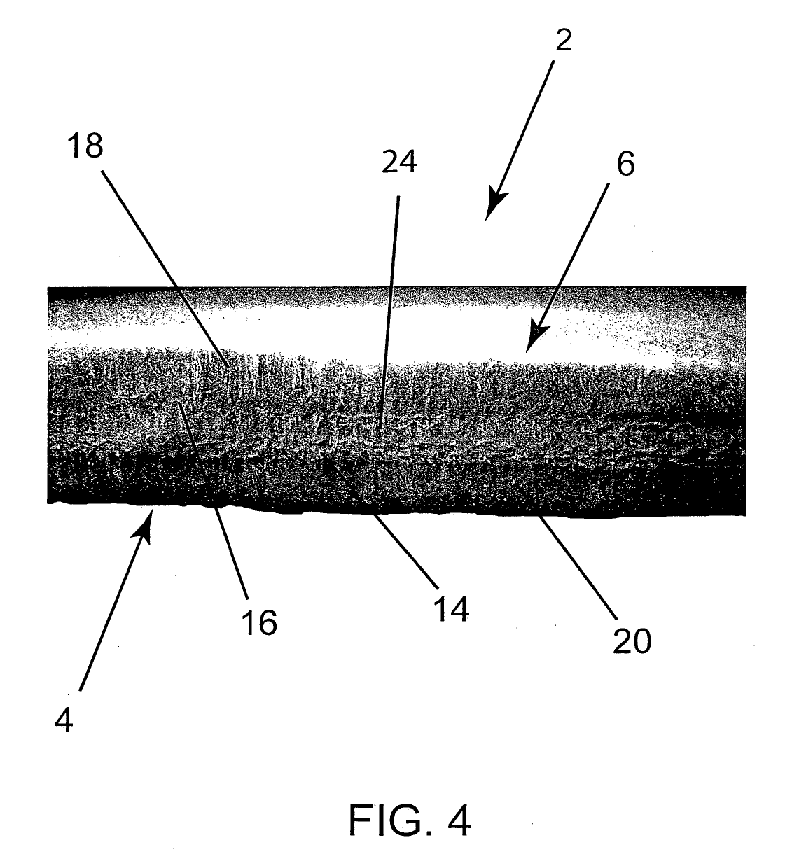

FIG. 3 depicts a multi-base needled belt constructed according to another embodiment of the instant invention. As depicted, a conventional base layer 14 is located adjacent to the internal machine side 4 of the belt 2 and an elastic base layer 16 is located adjacent to the external product side 6 of the belt 2. In this embodiment, however, the conventional base layer 14 and the elastic base layer 16 are separated by an additional batt layer 24. By adding this additional batt layer 24 to the belt 2, the elastic base layer 16 is positioned closer to the external product side surface 6 of the belt 2. In order to attach the conventional base layer 14, the additional batt layer 24 and the elastic base layer 16 to each another, a top or external batt layer 18 and a bottom or internal batt layer 20 are needled from an exterior surface of each base layer into the additional batt layer 24 and both base layers, 14 and 16. Therefore, the needled batt fibers 22 physically join the three layers to each other. The batt layers, 18 and 20, also provide a product side and a machine side contact surface. FIG. 4 is a photograph of a cross-section taken through a belt constructed according to this embodiment of the instant invention.

As a result of positioning the elastic base layer 16 closer to the external product side surface 6 of the belt 2 in both of the disclosed embodiments, the belt becomes more flexible. Therefore, the increased flexibility of the belt 2 reduces the formation of inconsistencies or irregularities in the external batt layer 18, thereby reducing marking of the textile cloth being processed. As is readily apparent to one skilled in the art, it is also possible to include an elastic base layer 16 adjacent to the internal machine side 4 of the belt 2. This results in a belt that has increased flexibility on its internal machine side 4 as well.

The conventional base layer 14 can be woven or knitted from monofilament, plied monofilament, multifilament or plied multifilament yarns or fibers. The yarns are typically extruded from any one of the synthetic polymeric resins, such as polyamide and polyester resins, used for this purpose by those of ordinary skill in the art.

The elastic base layer 16 is preferably flat woven. Standard elastic fibers, however, cannot be used for the elastic base layer 16 because standard elastic fibers are not suitable for the needling process as needling can damage the fibers. Therefore, the elastic fibers must be further processed to include a protective layer that may either be a physical or chemical treatment. Elastic fibers suitable for use in the elastic layer 16, include but are not limited to natural, nitrile or silicone rubber, LYCRA® and ELASTAN®. One way of protecting the elastic fibers is to process the fibers into a composite yarn such that the elastic fibers are primarily in the core or central portion of the yarn and wrapped with an outer protective layer of fiber such as, but not limited to, polyamide or polyester. This outer protective layer can be a multifilament yarn which is twisted or spiraled around the elastic core, or it may be of all multifilament construction.

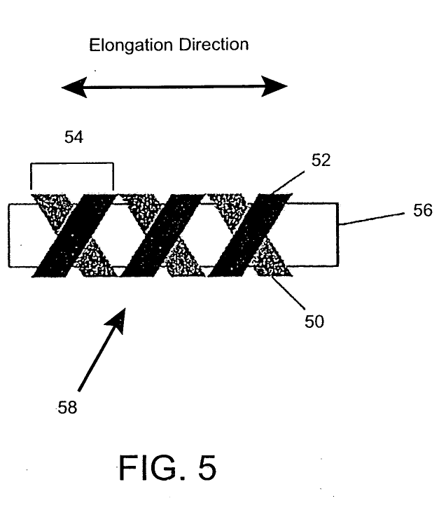

In order to allow the elastic core fibers to maintain their elasticity when fibers such as polyamide and polyester are used for the outer protective layer, the outer protective layer may comprise two fiber layers that are wrapped in a spiral manner around the elastic core in opposite directions. That is, as depicted in FIG. 5, the first fiber layer 50 of the outer protective layer is wrapped or spiraled onto the elastic core 56 in one direction. Once the first fiber layer 50 is spiraled on, a second fiber layer 52 is wrapped or spiraled onto the first fiber layer 50 in a direction opposite to that of the first layer.

In this configuration, the spiralized outer protective layer remains “closed” when the elastic composite yarn is not under tension or relaxed. This results in an elastic core 56 that is fully covered by the outer protective layer, which prevents the elastic core 56 from being significantly damaged during the needling process. As depicted in FIG. 5, when the composite yarn 58 is placed under tension or stretched in the direction indicated in the figure, the spiralized first fiber 50 and second fiber 52 of the outer protective layer “open” into an “X” shape 54. This allows the elastic core 56 and hence the composite yarn 58 to stretch or expand in the direction indicated in the figure.

Alternatively, the elastic fibers can be protected with the application of a polymeric coating, such as but not limited to, polyurethane or silicone. Treatment of the elastic fibers with these coatings prevents significant needling damage and assures good adhesion between the batt fibers and the elastic yarns. These coatings may also be applied to the composite yarns in order to provide further protection against significant needling damage and assure good adhesion between the batt fibers and the elastic yarns. The protective coatings further include coatings that are sprayed or dip-coated on the elastic yarns. Also, the coatings can be in the form of a sheath that is melt bonded to the yarn or so called sheath/core yarn produced for example during yarn extrusion or other methods known to those skilled in the art of yarn production. Additional methods to treat the yarn surface of the elastic yarns will be readily apparent to those skilled in the art.

Furthermore, because the elasticity of the instant belt derives from an elastic layer that is constructed with elastic yarns or fibers, the instant belt is not limited to flat weaves. Instead, additional textile forming techniques known to those skilled in the art, may be used to construct the elastic layer of the instant invention.

In addition, while needling is referred to as the means for attaching the layers of the laminated structure together, other ways will be apparent to those skilled in the art. For example lamination or attachment by heat fusion might be utilized especially if components of certain layers contain a material with a lower melting point. In this regard the batt layer(s) could include a “low melt” binder fiber, especially the situation where the batt has an interior batt layer. One might consider a combination of both needling and some heat fusion or other attachment mechanism suitable for the purpose. In this regard such a combination will reduce the total amount of needling required to hold the structure together, positively impacting the desired result of minimizing damage to the elastic yarns. In the case of fusion attachment for example, the amount of fusion and the amount of “low melt” material and its location would have to be balanced against the need to have the belt perform in the desired manner as to both elongation and relaxation in the machine direction as well as the through thickness compression and rebound (resiliency). Too much “fusion” may affect the desired elastic behavior so a proper balancing needs to occur.

Although a preferred embodiment of the present invention and modifications thereof have been described in detail herein, it is to be understood that this invention is not limited to this precise embodiment and modifications, and that other modifications and variations may be effected by one skilled in the art without departing from the spirit and scope of the invention as defined by the appended claims. The use of the instant belt in accordance with the invention is not limited to machines for rendering textiles shrinkproof, in other words, the instant belt can be used anywhere where the requirements mentioned above are placed on the quality and serviceable life of the belt.

What is claimed is:

1. A multi-base textile belt comprising:
a synthetic polymeric resin base layer adjacent to a machine-side of said belt;
an elastic base layer adjacent to a product forming side of said belt;
a first batt layer on the machine side of said belt, wherein said first batt layer is attached to said synthetic polymeric base layer and said elastic base layer; and
a second batt layer on the product forming side of said belt, wherein said second batt layer is attached to said synthetic polymeric base layer and said elastic base layer.

2. The multi-base textile belt as claimed in claim 1, wherein said synthetic polymeric base layer is woven or knitted with synthetic polymeric resin yarns.

3. The multi-base textile belt as claimed in claim 1, wherein said elastic base layer is woven with elastic yarns.

4. The multi-base textile belt as claimed in claim 2, wherein said synthetic polymeric yarns are monofilament, plied monofilament, multifilament or plied multifilament yarns.

5. The multi-base textile belt as claimed in claim 1, wherein said synthetic polymeric resin is a polyamide or polyester resin.

6. The multi-base textile belt as claimed in claim 3, wherein said elastic yarns are selected from the group consisting of natural rubber, nitrile rubber, silicone rubber, LYCRA® and ELASTAN®.

7. The multi-base textile belt as claimed in claim 3, wherein said elastic yarns further include a protective layer.

8. The multi-base textile belt as claimed in claim 7, wherein said protective layer is a polymeric coating.

9. The multi-base textile belt as claimed in claim 8 wherein said protective layer is a silicone coating.

10. The multi-base textile belt as claimed in claim 8, wherein said polymeric coating is a polyurethane.

11. The multi-base textile belt as claimed in claim 7, wherein said protective layer is sprayed or dip-coated onto the elastic yarns or a sheath that is melt bonded to the elastic yarns.

12. The multi-base textile belt as claimed in claim 1, wherein at least one or both of said batt layers are attached by needling.

13. The multi-base textile belt as claimed in claim 3, wherein said elastic yarns are composite yarns having a core comprised of at least one elastic yarn and wherein disposed on said core is at least one protective layer of fiber.

14. The multi-base textile belt as claimed in claim 13, wherein said at least one protective layer of fiber is wrapped onto said core in a twisted or spiraled manner.

15. The multi-base textile belt as claimed in claim 3, wherein said elastic yarns are composite yarns having a core comprised of at least one elastic yarn and wherein disposed on said core is a first protective layer of fiber and a second protective layer of fiber.

16. The multi-base textile belt as claimed in claim 15, wherein said first protective layer of fiber is wrapped onto said core in a first direction and said second protective layer of fiber is wrapped onto said first protective layer of fiber in a second direction that is opposite to the first direction.

17. The multi-base textile belt as claimed in claim 13, wherein said at least one protective layer of fiber further includes a polymeric coating.

18. The multi-base textile belt as claimed in claim 15, wherein said first protective layer of fiber and a second protective layer of fiber further include a polymeric coating.

19. A multi-base textile belt comprising:
a woven or knitted first base layer comprised of synthetic polymeric resin yarns adjacent to a machine-side of said belt;
a woven second base layer comprised of elastic yarns adjacent to a product forming side of said belt;
a first batt layer on the machine side of said belt, wherein said first batt layer is attached to said woven or knitted first base layer and said woven second base layer; and
a second batt layer on the product forming side of said belt, wherein said second batt layer is attached to said woven or knitted first base layer and said woven second base layer.

20. The multi-base textile belt as claimed in claim 19, wherein said yarns in said woven or knitted first layer are monofilament, plied monofilament, multifilament or plied multifilament yarns.

21. The multi-base textile belt as claimed in claim 19, wherein said synthetic polymeric resin is a polyamide or polyester resin.

22. The multi-base textile belt as claimed in claim 19, wherein said elastic yarns are selected from the group consisting of natural rubber, nitrile rubber, silicone rubber, LYCRA® and ELASTAN®.

23. The multi-base textile belt as claimed in claim 19, wherein said elastic yarns further include a protective layer.

24. The multi-base textile belt as claimed in claim 23, wherein said protective layer is a polymeric coating.

25. The multi-base textile belt as claimed in claim 24 wherein said protective layer is a silicone coating.

26. The multi-base textile belt as claimed in claim 24, wherein said polymeric coating is a polyurethane.

27. The multi-base textile belt as claimed in claim 23, wherein said protective layer is sprayed or dip-coated onto the elastic yarns or is a sheath that is melt bonded to the elastic yarns.

28. The multi-base textile belt as claimed in claim 19, wherein at least one or both of said batt layers are attached by needling.

29. The multi-base textile belt as claimed in claim 19, wherein said elastic yarns are composite yarns having a core comprised of at least one elastic yarn and wherein disposed on said core is at least one protective layer of fiber.

30. The multi-base textile belt as claimed in claim 29, wherein said at least one protective layer of fiber is wrapped onto said core in a twisted or spiraled manner.

31. The multi-base textile belt as claimed in claim 19, wherein said elastic yarns are composite yarns having a core comprised of at least one elastic yarn and wherein disposed on said core is a first protective layer of fiber and a second protective layer of fiber.

32. The multi-base textile belt as claimed in claim 31, wherein said first protective layer of fiber is wrapped onto said core in a first direction and said second protective layer of fiber is wrapped onto said first protective layer of fiber in a second direction that is opposite to the first direction.

33. The multi-base textile belt as claimed in claim 29, wherein said at least one protective layer of fiber further includes a polymeric coating.

34. The multi-base textile belt as claimed in claim 31, wherein said first protective layer of fiber and a second protective layer of fiber further include a polymeric coating.

35. A multi-base textile belt comprising:
a woven or knitted first base layer comprised of synthetic polymeric resin yarns adjacent to a machine-side of said belt;
a woven second base layer comprised of elastic yarns adjacent to a product forming side of said belt;
a first batt layer disposed between said woven or knitted first base layer and said woven second base layer;
a second batt layer on the machine side of said belt, wherein said second batt layer is attached to said woven or knitted first base layer, said first batt layer and said woven second base layer; and
a third batt layer on the product forming side of said belt, wherein said third batt layer is attached to said woven or knitted first base layer, said first batt layer and said woven second base layer.

36. The multi-base textile belt as claimed in claim 35, wherein said yarns in said woven or knitted first layer are monofilament, plied monofilament, multifilament or plied multifilament yarns.

37. The multi-base textile belt as claimed in claim 35, wherein said synthetic polymeric resin is a polyamide or polyester resin.

38. The multi-base textile belt as claimed in claim 35, wherein said elastic yarns are selected from the group consisting of natural rubber, nitrile rubber, silicone rubber, LYCRA® and ELASTAN®.

39. The multi-base textile belt as claimed in claim 35, wherein said elastic yarns further include a protective layer.

40. The multi-base textile belt as claimed in claim 39, wherein said protective layer is a polymeric coating.

41. The multi-base textile belt as claimed in claim 40 wherein said protective layer is a silicone coating.

42. The multi-base textile belt as claimed in claim 40, wherein said polymeric coating is a polyurethane.

43. The multi-base textile belt as claimed in claim 39, wherein said protective layer is sprayed or dip-coated onto the elastic yarns or is a sheath that is melt bonded to the elastic yarns.

44. The multi-base textile belt as claimed in claim 35, wherein at least one or more batt layers are attached by needling.

45. The multi-base textile belt as claimed in claim 35, wherein said elastic yarns are composite yarns having a core comprised of at least one elastic yarn and wherein disposed on said core is at least one protective layer of fiber.

46. The multi-base textile belt as claimed in claim 45, wherein said at least one protective layer of fiber is wrapped onto said core in a twisted or spiraled manner.

47. The multi-base textile belt as claimed in claim 35, wherein said elastic yarns are composite yarns having a core comprised of at least one elastic yarn and wherein disposed on said core is a first protective layer of fiber and a second protective layer of fiber.

48. The multi-base textile belt as claimed in claim 47, wherein said first protective layer of fiber is wrapped onto said core in a first direction and said second protective layer of fiber is wrapped onto said first protective layer of fiber in a second direction that is opposite to the first direction.

49. The multi-base textile belt as claimed in claim 45, wherein said at least one protective layer of fiber further includes a polymeric coating.

50. The multi-base textile belt as claimed in claim 47, wherein said first protective layer of fiber and a second protective layer of fiber further include a polymeric coating.
